(19) United States
(12) Patent Application Publication
(10) Pub. No.: US 2011/0186165 A1
(43) Pub. Date: Aug. 4, 2011

(54) THREE-DIMENSIONAL MICROFLUIDIC PLATFORMS AND METHODS OF USE AND MANUFACTURE THEREOF

(76) Inventors: Jeffrey T. Borenstein, Newton, MA (US); Joseph L. Charest, Cambridge, MA (US); Jessie Sungyun Jeon, Cambridge, MA (US); Roger D. Kamm, Cambridge, MA (US); Seok Chung, Seoul (KR); Ioannis Zervantonakis, Cambridge, MA (US); Vernella Vickerman, Cambridge, MA (US)

(21) Appl. No.: 12/898,307

(22) Filed: Oct. 5, 2010

Related U.S. Application Data
(60) Provisional application No. 61/248,603, filed on Oct. 5, 2009.

(51) Int. Cl. F15C 1/06; B29C 59/02

(52) U.S. Cl. 137/833; 156/196

(57) ABSTRACT

Microfluidic devices may be fabricated from thermoplastics using, for example, hot embossing techniques. In some embodiments, the devices feature non-uniform surface modifications.

### CROSS-REFERENCE TO RELATED APPLICATION

This application claims priority to and the benefit of U.S. Provisional Patent Application No. 61/248,603, filed on Oct. 5, 2009, which is incorporated herein by reference in its entirety.

### TECHNICAL FIELD

In various embodiments, the present invention relates to microfluidic platforms for cell studies, and methods of manufacture thereof.

### BACKGROUND

The microenvironment surrounding a cell significantly influences cell function through both biochemical and biophysical parameters. Most traditional platforms for studying the influence of these parameters on cell function are based on culture wells, simple flow chambers, or stretchable substrates in which, typically, one or a small number of factors can be controlled and studied. As an alternative to these conventional systems, microfluidic platforms may be used. Microfluidic systems generally enable precise control over multiple factors and over communication among multiple cell types in a single in vitro device, facilitate the establishment and control of biochemical or thermal gradients, and provide improved access for imaging. Further, microfluidic system may integrate three-dimensional scaffolds that enable cell migration studies in three dimensions, in contrast to most conventional platforms, which are limited to two-dimensional studies. For example, a microfluidic platform made of polydimethylsiloxane (PDMS) and including a three-dimensional (3D) gel microenvironment has been used to control and investigate angiogenesis arising from endothelial cells cultured within the device.

The performance, applicability, and manufacturability of a microfluidic device are largely dictated by material selection and fabrication methods. For example, PDMS, despite its wide use for microfluidic systems, has limitations from both a materials and a processing perspective. From a materials perspective, PDMS structures can absorb significant quantities of small molecules (such as hormones) as well as leach monomers into the channels, resulting in significant inaccuracy and transient behavior for any assay involving small molecules, such as the evaluation of a pharmaceutical compound. Further, since surface properties significantly alter protein adsorption, activity, and consequent function of cells bound to the proteins, the inherently hydrophobic surface and porous structure of PDMS may lead to an unknown and uncontrolled impact on cell function within the device. For example, the PDMS may result in an altered concentration of a specific molecule which has a significant impact on the experimental result, or an altered protein layer resulting in different cell signaling and differentiation. Further, even if the surface is rendered hydrophilic, e.g., by plasma treatment, it may not stay hydrophilic for a long time, and its properties may be highly unstable. In addition, the low elastic modulus of PDMS may allow significant dimensional changes of the microfluidic structures due to the pressure used to induce flow within the system. While thicker layers of PDMS may increase the mechanical stability of the device, they may also increase the size and cost of the device, and make imaging more difficult. From a processing perspective, PDMS fabrication methods limit mass production and automation. For example, the soft lithography method of fabricating PDMS devices involves several sequential steps, including a time-dependent curing step, which limits the ability to reduce cycle time and restricts the processing to batch fabrication. Moreover, post-curing solvent extraction of uncured oligomers from PDMS requires additional cycle time and may result in leaching of solvents into the cell culture space.

In addition to limitations associated with the use of PDMS, previous microfluidic devices typically feature uniform (if any) surface treatments, which—disadvantageously—fix topography, chemistry, surface energy, and hydrophobicity of the interior surface throughout the device, thereby potentially limiting device function. For example, 3D gel retention and cell adhesion, as well as protein adsorption and activity, cannot be modulated in a spatial manner with a uniform surface treatment.

Accordingly, there is a need for improved microfluidic platforms for cell culture and biological experimentation that enhance control over the microenvironment surrounding the cells, and are preferably susceptible of mass manufacture.

### SUMMARY

In various embodiments, the present invention provides microfluidic devices made of thermoplastics, as well as associated manufacturing methods. Thermoplastics are polymers that turn to a liquid when heated, and freeze to a glass-like state when cooled sufficiently. Typically, they facilitate control over surface properties and thereby enable specific functions. Further, they generally adapt well to simple, low-cost fabrication techniques. Thus, thermoplastics are advantageous materials for microfluidic cell culture platforms and, in particular, for commercial applications. Microfluidic devices may be manufactured from thermoplastics by hot-embossing a microfluidic pattern (including, e.g., microchannels and chambers) into a polymer substrate, and subsequently bonding a (typically thin and optically transparent) polymer sheet to the substrate so as to enclose the patterned microfluidic structures. Bonding may be achieved using roller-lamination. To enhance the bonding strength and, as a result, the device performance, the bonding surfaces of the substrate and/or thin sheet may be plasma-treated prior to bonding. Hot embossing provides a low-cost, high-throughput method to mold thermoplastics. In addition, it facilitates control of surface feature dimensions in the micro- and nanoscale, thereby allowing significant influence over cells via their microenvironment.

In some embodiments, the invention is directed to a microfluidic device that includes two microchannels separated by a three-dimensional scaffold, such as, e.g., a 3D gel matrix contained in a chamber fluidically coupling the channels. A microchannel or microfluidic channel, as the terms are interchangeably used herein, typically has dimensions perpendicular to a longitudinal axis of the channel (i.e., a path along which fluid flows during ordinary operation) that are smaller than 1 mm, and in some embodiments smaller than 100 μm. In general, the channel width depends on the particular application. For example, for creating cellular monolayers, channel widths may range, in certain embodiments, from about 400 μm to about 600 μm. The cross-sections of the microchannels (perpendicular to the respective longitudinal axes) may be rectangular, round, or have any other shape, and may (but need not) vary in size or shape along the longitudinal axes.

The three-dimensional scaffold allows fluid flow and cell migration therethrough and between the microchannels (i.e., it fluidically couples the channels). Thus, by establishing fluid flows in the two microchannels that differ in their respective pressures and/or the concentrations of one or more fluid constituents (e.g., a pharmaceutical compound, biochemical factor, etc.), a pressure and/or concentration gradient may be established across the 3D scaffold. In certain embodiments, the two microchannels have separate inlets, but merge downstream the 3D scaffold to share a common outlet. As a result, the pressures in the two channels are substantially equalized, such that a pressure gradient across the 3D scaffold is avoided, as is desired for some applications. At the same time, a controlled concentration gradient can be established across the 3D scaffold by injecting fluids of different compositions at the inlets upstream the scaffold.

The invention further features, in various embodiments, microfluidic devices with non-uniformly treated and/or patterned interior surfaces. The interior surface of a microfluidic device includes the walls of the microchannels as well as the walls of any other hollow spaces formed in the polymer (or other solid) structure defining the device, such as, e.g., the walls of the gel-holding chamber described above. Surface treatment and/or patterning include chemical and/or topographical surface modifications. Chemical modifications, in turn, include treatments and/or coatings with inorganic substances as well as with organic substances (such as, e.g., antibodies or proteins). Non-uniform surface treatment implies that one or more portions of, but less than the entire, surface is treated, or that different portions are treated in different ways. Patterning implies repetitive (although not necessarily perfectly regular) surface modifications. For example, in some embodiments, one or more microchannel walls feature chemically (including, e.g., biologically) treated islands, or non-treated islands defined by an otherwise treated surface area. Further, in some embodiments, certain interior surfaces are topographically structured, e.g., with microposts. Microposts disposed at the top and bottom surfaces of a gel-containing chamber may serve to hold the gel in place. Further, microposts and other topographical structures may be used to influence the interactions of cells with the walls. Microposts at oblique angles to the surface may, for instance, be used to adjust the apparent “softness” of the walls for purposes of cell-wall interactions.

Microfluidic devices as described herein may be used for culturing and observing cells in a controlled microenvironment. Applications include, for example, cell migration, proliferation, and differentiation studies (e.g., angiogenesis investigation), and the analysis of biophysical and biochemical factor influence on cell function (including, e.g., drug safety and efficacy testing). The microfluidic devices may achieve improved performance as a result of advantageous material selection (e.g., the use of thermoplastics) and/or manufacturing methods (e.g., thermal lamination of a polymer sheet to a (optionally plasma treated) micropatterned substrate), device designs that are uniquely adapted to a particular purpose (e.g., merged channels for pressure equalization), non-uniform surface modifications, or any combination thereof. Commercial applications of the devices described herein include, but are not limited to, evaluating cancer therapies, quantifying cell migration, diagnosing cell-based diseases, and testing pharmaceuticals.

Accordingly, the invention provides, in a first aspect, a microfluidic device that includes a thermoplastic polymer structure defining first and second microchannels, and a chamber laterally separating and fluidically coupling the first and second microchannels and containing a three-dimensional scaffold (e.g., a gel matrix). Portions of the first and second microchannels on opposite sides of the chamber may be substantially parallel (e.g., feature an angle therebetween of smaller than 10°, preferably smaller than 3°, and more preferably smaller than 1°). The first and second microchannels may have respective first and second inlets, and respective first and second outlets. In some embodiments, the first and second microchannels merge into a common channel portion having a single outlet.

The three-dimensional scaffold may include or consist essentially of a gel matrix, which may comprise a gel or gel-like material such as, e.g., collagen, fibronectin, hyaluronan, a hydrogel (such as, e.g., polyethylene glycol hydrogel), a peptide gel, or gel-like proteins or protein mixtures secreted by animal cells (e.g., Matrigel™). The thermoplastic polymer may be polystyrene, polydimethylsiloxane, polycarbonate, poly(methyl methacrylate), cyclic olefin copolymer, polyethylene, polyethylene terephthalate, polyurethane, polycaproleacton, polyactic acid, polyglycolic acid, or poly(lactic-co-glycolic acid). In some embodiments, different types of thermoplastic polymers are used for different components or portions of the polymer structure. The polymer structure may be substantially optically transparent (e.g., have a transmission in the visible range of more than 70%, preferably more than 90%, and more preferably more than 95%).

In certain embodiments, the upper and/or lower surface of the chamber features surface modifications, which may serve to hold the scaffold in place. For example, the surface(s) may be modified with microposts disposed thereon. Further, in some embodiments, the surface(s) of one or both microchannels, or one or more surface portions, are patterned (e.g., chemically or topographically). The surface patterning may be non-uniform.

In another aspect, the invention is directed to a microfluidic device including a (typically optically transparent) polymer structure that defines first and second microchannel portions merging into a third microchannel portion. Subportions of the first and second microchannel portions on opposite sides of the chamber may be substantially parallel. The device further includes a three-dimensional scaffold (including or consisting essentially of, e.g., a gel matrix) that laterally separates and fluidically couples the first and second microchannel portions. The first and second microchannel portions have respective first and second inlets (at ends opposite those where they merge into the third portion), and the third microchannel portion has an outlet (at an end opposite the merger point).

In a third aspect, a method of manufacturing a microfluidic device is provided. The method includes hot-embossing a master mold (made, e.g., of epoxy, silicon, or a metal) into a polymer substrate on a first side of the substrate so as to define in the substrate two microchannels separated and fluidically coupled by a chamber, and bonding a polymer sheet to the first side of the polymer substrate by lamination (e.g., thermal lamination and/or roller-lamination). The method may further involve plasma-treating at least a portion of the first side of the polymer substrate and/or the polymer sheet.

In a further aspect, various embodiments are directed to a microfluidic device including a polymer scaffold that defines at least one microchannel whose interior surface features inhomogeneous chemical (including anorganic as well as organic, or “biological”) modifications along a direction substantially perpendicular to a longitudinal axis of the channel. In some embodiments, the modifications include or consist of chemically treated islands or, alternatively, chemically treated regions defining untreated islands. In some embodiments, the modifications comprise chemically treated strips oriented along the longitudinal axis of the channel. The device may, in addition, feature topographical modifications.

In yet another aspect, the invention provides a microfluidic device including a polymer scaffold defining at least one microchannel whose interior surface features a plurality of microposts disposed on the surface at an oblique angle to the surface (e.g., in the range from about 10° to about 80°). The density and/or size of the microposts may vary along a longitudinal axis of the channel.

In a further aspect, a microfluidic device is provided that includes a polymer scaffold defining at least one microchannel, where an interior surface of the microchannel features chemical modifications patterned along a direction substantially perpendicular to the longitudinal axis of the channel and/or a direction substantially parallel to the longitudinal axis of the channel.

These and other features and advantages of the embodiments of the present invention herein disclosed will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the following description, various embodiments of the present invention are described with reference to the following drawings, in which:

FIG. 1 is a schematic top view of a microfluidic device structure featuring multiple fluid-matrix interfaces in accordance with one embodiment;

FIG. 2A is a schematic top view of a microfluidic device structure featuring microchannels that merge downstream a gel matrix in accordance with one embodiment;

FIG. 2B is an exemplary graph illustrating how a concentration gradient across the gel matrix is established in time in the device shown in FIG. 2A;

FIG. 2C is an exemplary graph illustrating the concentration gradient across the gel matrix in the device shown in FIG. 2A;

FIG. 3 is a schematic drawing illustrating a hard-embossing method of manufacturing microfluidic devices in accordance with various embodiments;

FIG. 4 is a schematic drawing of a plug structure usable to achieve non-uniform surface treatment in accordance with one embodiment; and

FIGS. 5A-5C are schematic drawings illustrating chemical surface patterning in accordance with various embodiments.

The drawings are not necessarily to scale, emphasis instead generally being placed upon illustrating the principles of the invention.

### DETAILED DESCRIPTION

1. Microfluidic Device Structures with Fluid-Matrix Interfaces

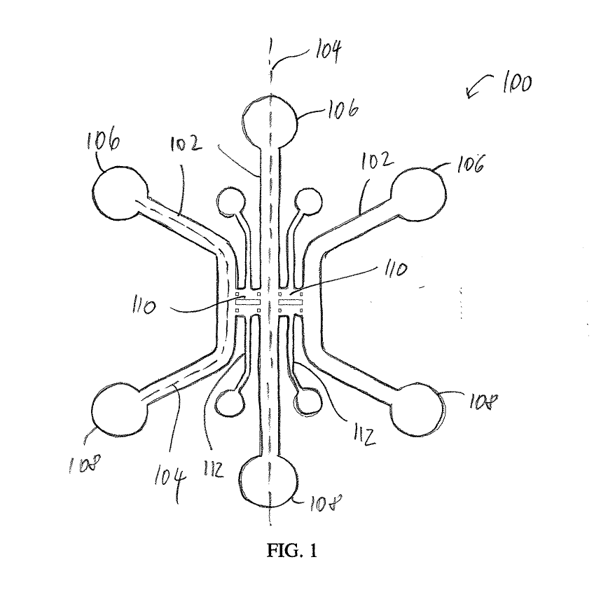

In various embodiments, the present invention provides microfluidic devices that include one or more fluid-matrix interfaces. An exemplary such device is illustrated schematically in FIG. 1 in top view. The device 100 includes three microchannels 102 whose longitudinal axes 104 run substantially parallel (e.g., include an angle of less than 1°) to one another in corresponding center portions of the channels 102, and diverge at the channel ends to provide better external access to channel inlets 106 and outlets 108. Fluid flow can be established, and fluidmechanical parameters can be controlled, in each microchannel 102 individually and independently by connecting the corresponding inlet 106 and outlet 108 to external fluidic components including, e.g., pumps and fluid reservoirs. In the illustrated embodiment, the three microchannels 102 have their inlets 106 at the same ends, such that, in operation, fluid flow in the parallel channel portions is in parallel. However, in alternative embodiments, the inlet of one microchannel 102 may be located next to an outlet of a neighboring microchannel 102 such that fluid flow through the two channels 102 is anti-parallel. The inlets 106 and/or outlets 108 may also serve to inject cells into the microchannels 102. The fluid compositions and cell types may vary between the channels 102. Typically, the fluid includes a cell culture medium and, optionally, certain concentrations of biochemical factors such as, e.g., pharmaceutical compounds, antibodies, growth factors, or fluorescently or otherwise labeled macromolecules. In some embodiments, however, the microfluidic device may be perfused with water, biological buffer, saline solution, whole blood, serum, plasma, surrogates of bodily fluids, or endogenous fluids such as, e.g., cerebrospinal fluid.

In their parallel center regions, the three microchannels 102 are laterally separated (“lateral” denoting a direction perpendicular to the longitudinal channel axes) and fluidically connected by chambers 110. The chambers 110 may each contain a 3D scaffold or matrix that mimics vascular tissue, or another relevant in-vivo microenvironment of the cells under study in the device 100. The 3D scaffold is typically a gel matrix (such as, e.g., a collagen, Matrigel™, fibronectin, hyaluronan, polyethylene glycol hydrogel, or peptide gel matrix), which may be injected into the chambers 110 via auxiliary microchannels 112 located between the microchannels 102 that serve to establish fluid flow. Alternatively, in some embodiments, the gel may be injected into the open chamber before the cover polymer sheet is bonded to the substrate. In some embodiments, the scaffold comprises topographical features molded into the device, or a material cured in place and rendered porous by means of, e.g., solvent etching, solute leaching, or degradation. Adjacent the chambers 110, the side walls of the microchannels 102 open up to provide an interface between the fluid flow in the channels 102 and the matrix, and allow cells to proliferate and migrate through, and/or attach to, the matrix. Biochemical and biophysical factors may be controlled in the device 100 to influence angiogenic sprouting and cell migration. For example, biochemical compounds may be carried in the culture medium, and fluid-mechanical parameters (such as flow rate and pressure) may be controlled via the fluidic components external to the device 100.

The device 100 may be modified in various ways. For example, a microfluidic device with similar functionality may have only two microchannels 102 for fluid flow separated by a single matrix-filled chamber 110, or it may include more than three microchannels 102. Two neighboring channels may be separated by two or more distinct 3D matrices. In some embodiments, the channel portions on both sides of a 3D matrix may not be parallel to one another, but include a non-zero angle. Further, the width or cross-sections of the microchannels 102 may vary along the longitudinal axes. In certain embodiments, the matrix and microfluidic channels may be coupled via additional, intermediate device components, such as a one or more short channel portions perpendicular to the main channels 102.

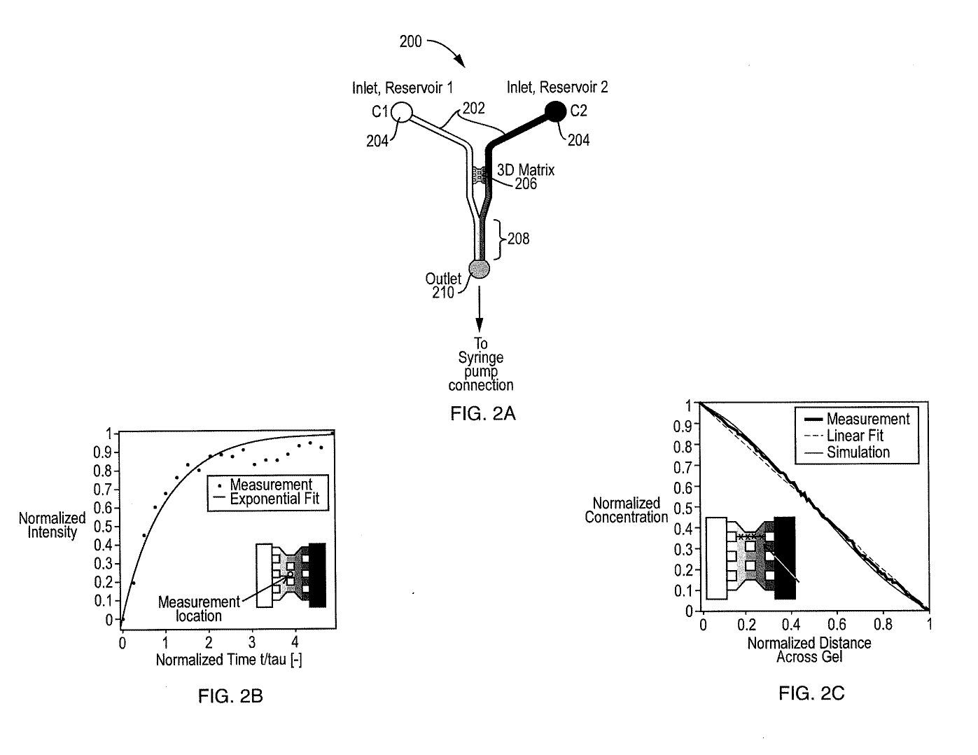

FIG. 2A shows an alternative design of a microfluidic device 200 in accordance with one embodiment of the invention. The device 200 includes two microchannels 202 having respective fluid inlets 204, and including substantially parallel channel portions that are fluidically coupled by a 3D matrix 206 downstream the inlets 204. Downstream the 3D matrix 206, the two microchannels 202 merge into a third, common channel portion 208 with a single outlet 210. As a result, the fluid channels have a “Y”-type geometry. In use, fluids of different compositions and/or concentrations may enter the inlets 204, thereby establishing a concentration gradient across the matrix 206. In the common channel portion 208, the fluids mix, so that, in order to maintain the concentration gradient for a period of time, fresh solutions need to be injected at the inlets (whereas in a device 100, fluids may, in principle, be recycled from the outlets 108 to the corresponding inlets 106). In some embodiments, the inlets 202 are connected to fluid reservoirs, and fluid is pumped out of the channels at the outlet 210 using a syringe pump connected thereto. Alternatively, the inlets may be connected to pumps, while the outlet is leading to a reservoir.

FIGS. 2B and 2C illustrate the establishment of an exemplary concentration gradient across the matrix 206. Herein, the local concentration of a fluorescent component of the fluid is measured in terms of the intensity of fluorescent light emitted from the component. In FIG. 2B, the intensity in the center of the matrix is plotted as a function of time, measured from the initiation of fluid flows in the channels 202. FIG. 2C shows the concentration as a function of lateral position across the gel under steady-state conditions (i.e., at a time, when the intensity graphed in FIG. 2B has substantially reached its asymptotic value).

The Y-design of the device 200 is usually preferable over that of device 100 in situations where a chemical (i.e., concentration) gradient is desired while a pressure gradient across the matrix is to be avoided. While it may be possible, using a device like that shown in FIG. 1, to manually control the fluid-mechanical parameters such that the pressures in the channels are substantially equal on both sides of the matrix, a device 200 in which the channels merge near the matrix 206 inherently achieves pressure equalization, and thereby eliminates the need for potentially complicated monitoring and control procedures. For some applications, however, a pressure gradient across the matrix is desired. The device 100 shown in FIG. 1, or a modification thereof, facilitates deliberately introducing such a pressure gradient.

In principle, microfluidic structures as described above may be made of PDMS or another soft polymer, using soft lithography methods as are known to those of ordinary skill in the art. However, to improve device performance and facilitate mass manufacture, it may be advantageous to manufacture the devices from hard plastics, in particular, thermoplastics, as described in more detail below.

### 2. Material Selection and Manufacturing

In various embodiments, microfluidic devices in accordance with the invention, such as those described with respect to FIGS. 1 and 2A above, are manufactured from hard polymers (or “hard plastics”). Hard plastics generally provide the advantages—compared with, e.g., PDMS—of greater hydrophilicity, amenability to surface treatments, manufacturability by commercially viable embossing techniques, and mechanical stiffness and robustness. Suitable hard polymer materials include thermoset polymers such as, for example, polyimide, polyurethane, epoxies, and hard rubbers, as well as thermoplastic polymers such as, for example, polystyrene, polydimethylsiloxane, polycarbonate, poly(methyl methacrylate), cyclic olefin copolymer, polyethylene, polyethylene terephthalate (PET), polyurethane, polycaproleacton (PCA), polyactic acid (PLA), polyglycolic acid (PGA), and poly(lactic-co-glycolic acid) (PGLA). Some of these materials (e.g., PCA, PLA, PGA, and PGLA) are biodegradable, and therefore also suitable for tissue engineering applications.

A particularly suitable material, among many thermoplastic materials, is cyclic olefin copolymer (COC), which has good optical, chemical, and bulk properties. For example, COC exhibits strong chemical resistance and low water absorption, which are important characteristics for devices often sterilized in chemical solvents and used in aqueous environments. Further, COC has a wide spectrum of optical transmission and exhibits low autofluorescence, thereby facilitating phase and fluorescent imaging of the cells and/or fluid constituents. Manufacturers offer several types of COC with different glass transition temperatures, allowing optimal COC material selection depending on device requirements and processing constraints. In some embodiments, different components of the polymer structure are made of different types of COC. For example, in one embodiment, the polymer substrate defining the microchannels and chambers is an approximately 2 mm thick layer of Zeonor 1060R, available from Zeon Chemicals (Louisville, Ky.) and having a glass transition temperature of about 100° C., and the thin film layer covering the open structures is an approximately 100 μm thick film of Topas 8007, available from Topas (Tokyo, Japan) and having a glass transition temperature of about 77° C. In alternative embodiments, the materials may be chosen such that the glass-transition temperature of the substrate is the same as or lower than that of the sealing layer. Further, depending on the requirements of particular applications, the sealing layer may be substantially thicker than 100 μm, e.g., it may have a thickness comparable to that of the substrate.

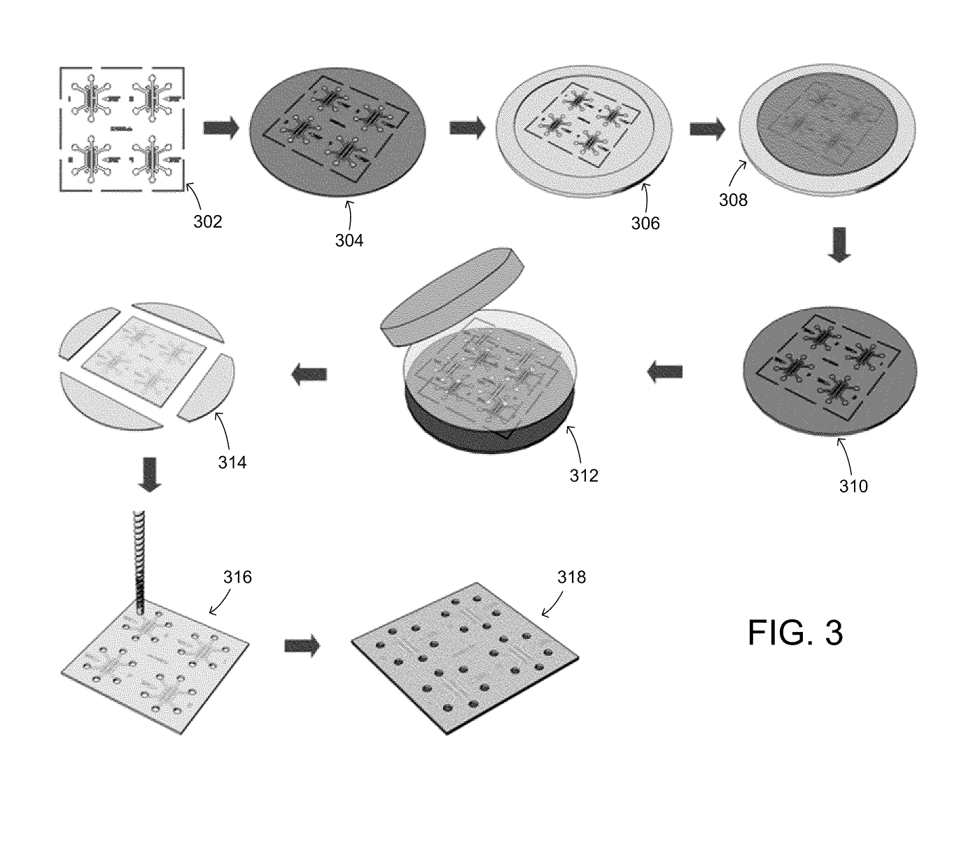

Hard polymer materials facilitate hot embossing (or, in some embodiments, cold embossing) methods for device fabrication. FIG. 3 illustrates an exemplary manufacturing sequence (for four devices 100), using hot embossing with an epoxy master. The process begins with the design and fabrication of a photomask defining the microchannels and chambers (step 302), followed by photolithographic patterning of a (for example, standard 4-inch) silicon wafer coated with photoresist (step 304). In one embodiment, the patterning step 304 involves spin-coating the pre-baked, clean silicon wafer with SU8 photoresist (available, e.g., from MicroChem, Mass., USA) twice at 2000 rpm for 30 seconds; placing the photomask onto the wafer with a mask aligner (e.g., Karl Suss MA-6; Suss America, Waterbury, Vt.) and exposing the wafer to UV light; developing the wafer for 12 minutes in a developer (e.g., Shipley AZ400K); and baking the wafer at 150° C. for 15 minutes. In the resulting SU8 pattern, the microchannels and chambers correspond to raised features having, in one embodiment, a height of 110 μm±10 μm.

The patterned SU8 photoresist serves as a mold to create a second, negative replica cast mold of PDMS (e.g., Sylgard 184 from Dow Chemical, Mich., USA) (step 306). In one embodiment, the PDMS base elastomer and curing agent are mixed in a 10:1 ratio by mass, poured on the patterned SU8 wafer, placed under vacuum for about 30 minutes to degas, and cured in an oven at 80° C. for more than 2 hours. In the PDMS mold, the channels are recessed. A durable epoxy master mold may subsequently be created from the PDMS mold (step 308). In one embodiment, this is accomplished by mixing Conapoxy (FR-1080, Cytec Industries Inc., Olean, N.Y., USA) in a 3:2 volume ratio of resin and curing agent, pouring the mixture into the PDMS mold, and curing it at 120° C. for 6 hours.

The cured epoxy master is then released from the PDMS mold (step 310), and hot-embossed into a COC or other thermoplastic substrate (step 312) to form the microfluidic features. The embossing step 312 is typically carried out under load and elevated temperatures, for example in a press that facilitates controlling the temperature via a thermocoupler and heater control system, and applying pressure via compressed air and vacuum. Temperature, pressure, and the duration of their application while the epoxy master mold is in direct contact with the substrate constitute manufacturing parameters that may be selected to optimize the fidelity of the embossed features, and the ability to release and mechanical properties of the embossed layers. In one embodiment, the COC (or other thermoplastic) plate is placed on the epoxy master, loaded into the press, and embossed at 100 kPa and 120° C. for one hour. The resulting embossed plates are then cooled to 60° C. under 100 kPa pressure, unloaded from the press, and separated from the epoxy master mold.

A durable master mold that can withstand high temperatures and pressures and serves as a stamp for embossing the microfluidic pattern into the thermoplastic wafer need not necessarily be made from epoxy. In alternative embodiments, etched silicon or electroformed or micromachined metal (e.g., nickel) molds may be used. Epoxy masters are advantageous because they are not only durable, but also comparatively inexpensive to fabricate.

Returning to FIG. 3, the embossed thermoplastic plates may be trimmed (step 314), and holes for fluidic connections may be drilled (step 316), punched, or cut. (In certain alternative embodiments, the holes are created before the embossing step.) The embossed and drilled device may then be cleaned in a sonicator using acetone, followed by rinsing with isopropyl alcohol (IPA). The microfluidic features may then be sealed through the bonding of a thin polymer layer to the substrate (step 318). In some embodiments, either one or both of the surfaces to be bonded are plasma-treated to increase the bond strength and to control (and, generally, decrease) the hydrophobicity of the interior surfaces. The bonding may be accomplished by lamination using, e.g., a laminating roller or laminating chamber. During the lamination, heat and pressure may be applied to thermally bond the layers. Alternatively or additionally, an adhesive or molecular chemical surface treatment may be used to achieve bonding. In one embodiment, after sonication in ethanol, the embossed COC plates receive an oxygen plasma treatment using a Technics plasma etcher (available from Technics Inc., Dublin, Calif., USA) for 30 seconds at 100 W and under a pressure of 13 Pa. Then, the embossed plate and a thin film of COC on top covering the microfluidic channels is preheated on a hot plate for 20 minutes at 77° C. The embossed plate and film are then run between two rollers heated to 120° C. for lamination by thermal fusion bonding.

After completion of the device assembly, the devices may be sterilized using ethylene oxide (ETO) for 24 hours. A collagen or other gel may then be injected. To facilitate adhesion of the collagen gel to the COC structure as well as cell attachment within the device, the inner surfaces of the device may be soaked in 1 mg/ml poly-d-lysine (PDL) coating solution (available from Sigma-Aldrich, St. Louis, Mo., USA) for at least three hours.

Hot embossing, as described above, is a high-throughput and easily scalable technique, leading to faster and cheaper production. The inexpensive high-throughput fabrication of microfluidic devices, in turn, may yield broad distribution of the devices, enabling access to personalized diagnosis, large sample sizes for robust data collection, and high-throughput screening. Further, using hard plastics is advantageous because they are generally not porous and less hydrophobic than materials such as PDMS. These properties reduce the undesirable absorption of hydrophobic proteins.

### 3. Surface Treatment and Patterning

Microfluidic devices in accordance with various embodiments feature surface modifications that may alter functionality, improve performance, restrict adsorption of substances and cell adhesion, and/or enable specific applications of the technology (e.g., cell-function assays, therapeutic cell population culture in bioreactors with well-controlled conditions, drug screening, drug delivery, vascular access, medical diagnostics, or other medical applications). In general, the surface modifications may comprise or consist of topographical components, chemical components, or combinations of topographical and chemical components. Topographical surface modifications include recessed or raised mechanical features, including, e.g., ridges, groves, steps, and/or microposts. Chemical surface modifications include, for example, metal coatings, self-assembled monolayers (SAMs), covalently-linked chemistries, chemically or physically deposited materials (including, e.g., biological molecules such as proteins or antibodies), and energetic modification of the device surfaces (e.g., achieved by oxygen plasma treatments).

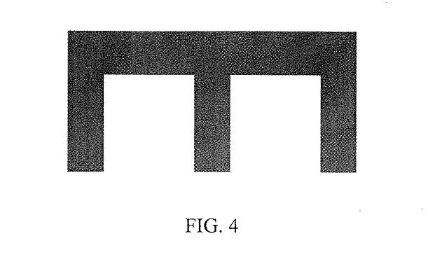

The surface modifications may be uniform over the device, or restricted to designated areas. In some embodiments, surfaces or portions thereof are patterned, i.e., modified in a non-homogenous way, typically with a degree of repetition. For example, a channel surface may be modified with a plurality of chemically treated “islands,” or an array of micropillars disposed on the surface. Surface treatment and patterning is typically accomplished prior to the device assembly. For example, the bottom walls of microchannels and chambers embossed into a polymer substrate may be modified using photopatterning, shadow mask techniques, micro-contact printing, molding, or similar techniques while the structures are open, allowing access from the top. Similarly the top walls of the microfluidic spaces may be patterned onto the underside of the polymer layer covering the channels prior to bonding that layer to the substrate. Certain non-uniform surface modifications can be implemented in the fully assembled device. For example, microfluidic methods may facilitate control over fluid flow patterns through the device so as to selectively expose some, but not all, interior surface regions to a chemical treatment solution. Another possibility is the use of a “plug” that may be inserted into the channels to block fluid access in certain regions, thereby protecting the interior surfaces in these regions from treatment. FIG. 4 illustrates an exemplary plug (manufacturable, e.g., from PDMS), which may be used to block three channel portions. The plug may be sufficiently elastic to conform its shape to bent or curved channels as well as to various channel cross-sections.

In certain embodiments, the surface modifications are selectively applied to areas that serve gel filling and retention. For example, in some embodiments, the gel-filling regions of a microfluidic device 100 or 200 (including, e.g., the chambers and/or auxiliary microchannels for gel injection) are stepped in deeper than the media-flowing channels, allowing them to be selectively coated with a solution such as Poly D Lysine (PDL) that enhances binding of collagen gel (as compared with the uncoated flow channels). The varying heights of the microfluidic structure can be achieved by embossing with a master mold whose features corresponding to the gel injection regions have a higher protrusion. Further, in some embodiments, an energetic modification of the device surfaces, such as an oxygen plasma treatment, is restricted to specific areas to control their relative hydrophobicity and hydrophilicity. The hydrophilic areas generally encourage wetting of the gel matrix, while the hydrophobic areas restrict wetting of the gel matrix, thereby limiting the function of the gel matrix to user-defined areas. A difference in hydrophilicity between the chamber walls and the microchannel walls (the hydrophilicity being higher in the chamber) may be used to prevent gel leaking into the channels. Control over surface hydrophilicity may also facilitate guiding a gel (in its fluid form) during the injection phase. This eliminates or reduces the need for guiding the gel by the surface tension of posts, thereby reducing the complexity of the device design, enabling larger gel-to-cell interface areas (and, thus, increased regions amenable to study), and introducing fewer artificial solid obstructions around cells.

Gel retention may also be improved by topographical surface features that lock the gel in place, thereby reducing the need for large gel-retaining structures, which might otherwise influence cell response and complicate flow pathways through the gel, resulting in the confounding of cell-response data. Smaller gel-retaining structures generally provide more consistent testing conditions for studying cell-matrix interactions and, thus, may improve the quality of the collected data. An exemplary topographic pattern comprises submicron-diameter pillars or posts located at the top and/or bottom surface of the gel chambers. The height of the pillars is chosen such that they provide a user-defined texture to lock the gel in place while remaining outside the cell-migration area of the gel (so as to prevent interference with cell migration). Micropillars may render gel fixation more robust, while enabling a wider range of gel chamber geometries and gel densities. This flexibility, in turn, enables the device to be used for assays involving multiple directions of cell migration and/or migration through a very thin layer of matrix, and facilitates more precise analysis of cell migration.

In addition to improving gel localization, chemical and/or topographical surface modification may be used to improve many other functional aspects of microfluidic devices. For instance, a surface chemistry may be used to suppress cell adhesion to certain areas so as to enhance optical access, and—as a result—improve the collection of data. In one embodiment, for example, a polyethylene glycol-presenting self-assembled monolayer applied to the top wall of a channel suppresses cell adhesion in that area, allowing microscopic inspection of events in the channel. Surface chemistries may also be employed to ensure a desired, well-characterized level of protein adsorption and activity. Since adsorbed protein quantity and activity can significantly influence cell function, the resulting protein layer reduces the variability of cell function, and improves the quality of data obtained with the device. In some embodiments, a chemical may be covalently linked to the device surface to reduce clotting, enabling the device to be used in assays involving whole blood (e.g., an extravasation assay, in which the device is perfused with a blood sample instead of a media solution). The use of whole blood may facilitate the detection and/or study of blood-based cancer cells and circulating tumor cells.

Surface treatments may also be used to preferentially bind specific cell types in order to isolate a cell type of interest from a complex mixture of cells, such as a sample taken from a patient. For example, tethering antibodies specific to a cancer-cell receptor to the device surfaces encourages preferential binding of cancer cells, which may be the cells of interest in a particular assay. Other cell types bind to the antibodies with lower affinity and frequency, and may further be prevented from binding to the surfaces by a cell-adhesion-suppressing component added to the surface treatment. Patterning of the surface chemistry enables restriction of those cells to active areas of the device, such as the gel, while limiting cell binding to other areas of the device that may detract from device performance. Moreover, patterned surface treatments that restrict cell adhesion to particular locations also enables the analysis of multiple cell types within the same device, rather than limiting the device function to one specific cell type (as controlled by the surface treatment).

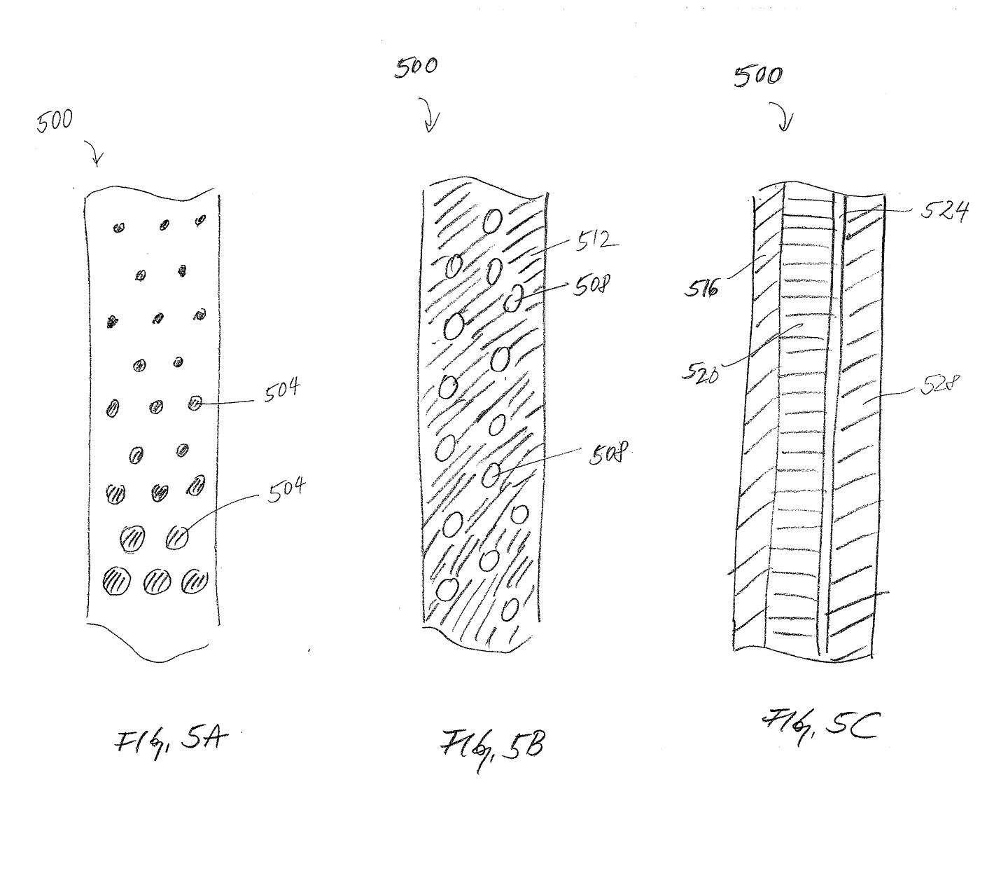

FIGS. 5A-5C conceptually illustrate various chemical surface patterns that may be used to manipulate the functionality of microfluidic channels. In FIG. 5A, a channel wall 500 is patterned by chemically treated “islands” 504, which may, for example, selectively bind certain types of cells. The pattern runs both in a direction along the channel as well as direction perpendicular thereto. The inverse situation is shown in FIG. 5B, where non-treated islands 508 are surrounded by a contiguous chemically treated area 512. The island dimensions are generally smaller than the local channel width. In some embodiments, islands having diameters of about 10 μm may be patterned onto the walls of a 100 μm-wide channel. The density and/or size of the islands may vary along the length of the channel (i.e., along a longitudinal axis). In certain embodiments, such density or size gradients are used to establish a chemical gradient between the channel inlet and outlet by extracting certain compounds from, or releasing them into, the fluid at a rate that depends on the position along the channel. FIG. 5C illustrates a microchannel wall whose surface is laterally divided into parallel strips 516, 520, 524, 528 of different surface chemistries. This type of surface pattern may be used, for example, to cause selective adhesion of various cell types to the different strips, resulting in a high level of cellular organization at the channel walls. Further, the surface patterns depicted in FIGS. 5A-5C may be used to control cell density in the channel, which, in turn, may influence the gradient of soluble factors secreted by the cells as well as the ability of the cells to signal each other. For example, the presence of a precise density of certain cell types may signal or block signaling of biological processes within the fluid (e.g., clotting or inflammation in the blood).

In some embodiments, one or more walls of a microchannel are modified by topographical patterns that may enhance, accelerate, or direct cell migration, thereby providing a platform for directional migration studies. For example, topographical features may provide mechanical guidance to the cells, and thus encourage preferential migration of cells along the patterned features. This effect may be exploited, for example, to expedite results by biasing cell migration along an axis that promotes integration with the gel. In certain embodiments, the topographical pattern includes an array of microposts disposed on the channel surface. The posts may have, for example, round, elliptic, square, or rectangular cross sections, whose aspect ratios (e.g., the ratio of the longer to the shorter edge of a rectangular cross section) may be selected to provide desired mechanical guidance for cells. The cross section may vary in shape or size along the length of the microposts. For example, the posts may be pointed or round at the top, and have the overall shape of, e.g., tapered pyramids, thin spatulas, or a more complex geometric objects. The posts may be arranged in a regular fashion (e.g., at the grid points of a regular mesh grid spread across the surface), or in a (usually deliberately) randomized manner. Their size and density may be constant throughout the channel, vary monotonously from one channel end to the other, or vary in a non-monotonous manner.

In certain embodiments, the posts are oblique, rather than perpendicular, to the surface. For example, the angle included between the microposts and the surface may be smaller than about 80°, smaller than about 60°, or smaller than about 45°. Tilting the microposts may affect the effective modulus of the topographically patterned walls, and thus modify the “softness” of the walls perceived by the cells. Because cells often respond significantly to the modulus of the material to which they are adherent, altering the surface modulus may, in some embodiments, be important for maintaining proper cell function in the channels. Tilting may also render the apparent modulus anisotropic, which may induce, for example, preferential cell migration in one direction of the channel. Directed migration may accelerate or enhance migration effects that would otherwise be too minute or slow to be observed in a feasible and convenient timeframe.

As will be apparent to a person of skill in the art, the surface modifications described above may be combined and modified in numerous ways. For example, chemical and topographical surface patterning may be employed in the same device, and multiple functions may often be achieved simultaneously. Further, the surface treatments and patterns described herein are, in general, not limited to the specific device structures described above with reference to the exemplary designs shown in FIGS. 1 and 2A, but are instead applicable to other microfluidic devices as well.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes that come within the meaning and range of equivalency of the claims are therefore intended to be embraced.

What is claimed is:

1. A microfluidic device, comprising:
a thermoplastic polymer structure defining therein (i) first and second microchannels, and (ii) a chamber laterally separating and fluidically coupling the first and second microchannels; and
a three-dimensional scaffold contained in the chamber.

2. The device of claim 1, wherein portions of the first and second microchannels on opposite sides of the chamber are substantially parallel.

3. The device of claim 1, wherein the first and second microchannels have respective first and second inlets.

4. The device of claim 1, wherein the first and second microchannels have respective first and second outlets.

5. The device of claim 1, wherein the first and second microchannels merge into a common channel portion having an outlet.

6. The device of claim 1, wherein the three-dimensional scaffold comprises a gel matrix.

7. The device of claim 6, wherein the gel matrix comprises at least one of collagen, fibronectin, hyaluronan, a hydrogel, a peptide gel, or gel-like proteins secreted by animal cells.

8. The device of claim 1, wherein the thermoplastic polymer comprises at least one of polystyrene, polydimethylsiloxane, polycarbonate, poly(methyl methacrylate), cyclic olefin copolymer, polyethylene, polyethylene terephthalate, polyurethane, polycaproleacton, polylactic acid, polyglycolic acid, or poly(lactic-co-glycolic acid).

9. The device of claim 1, wherein the chamber features a surface modification to at least one of an upper and a lower surface thereof for holding the scaffold in place.

10. The device of claim 9, wherein the surface modification comprises microposts disposed on the at least one surface of the chamber.

11. The device of claim 1, wherein at least a portion of a surface of at least one of the first and second microchannels is patterned.

12. The device of claim 11, wherein the surface patterning is non-uniform.

13. The device of claim 11, wherein the surface patterning comprises at least one of chemical or topographical patterning.

14. The device of claim 1, wherein the polymer structure is substantially optically transparent.

15. A microfluidic device, comprising:
a polymer structure defining first and second microchannel portions therein, the first and second microchannel portions having respective first and second inlets at first ends thereof, and merging into a third microchannel portion at second ends thereof, the third microchannel portion having an outlet; and
a three-dimensional scaffold laterally separating and fluidically coupling the first and second microchannel portions.

16. The device of claim 15, wherein subportions of the first and second microchannel portions on opposite sides of the chamber are substantially parallel.

17. The device of claim 15, wherein the three-dimensional scaffold comprises a gel matrix.

18. The device of claim 15, wherein the polymer structure is substantially optically transparent.

19. A method of manufacturing a microfluidic device, comprising:
hot-embossing a master mold into a polymer substrate on a first side thereof so as to define two microchannels separated and fluidically coupled by a chamber in the polymer substrate; and
bonding a polymer sheet to the first side of the polymer substrate using lamination.

20. The method of claim 19, further comprising plasma-treating at least a portion of at least one of the first side of the polymer substrate and the polymer sheet.

21. The method of claim 19, wherein the lamination comprises roller lamination.

22. The method of claim 19, wherein the lamination comprises thermal lamination.

23. The method of claim 19, wherein the master mold comprises a material selected from the group consisting of epoxy, silicon, and metal.

24. A microfluidic device, comprising:
a polymer scaffold defining at least one microchannel therein, an interior surface of the microchannel featuring inhomogeneous chemical modifications along a direction substantially perpendicular to a longitudinal axis of the channel.

25. The device of claim 24, wherein the modifications comprise chemically treated islands.

26. The device of claim 24, wherein the modifications comprise chemically treated regions defining untreated islands.

27. The device of claim 24, wherein the chemical modifications comprise chemically treated strips oriented along the longitudinal axis of the channel.

28. The device of claim 24, further comprising topographical modifications.

29. A microfluidic device, comprising:
a polymer scaffold defining at least one microchannel therein, an interior surface of the microchannel featuring a plurality of microposts disposed on the surface at an oblique angle thereto.

30. The device of claim 29, wherein a density of the microposts varies along a longitudinal axis of the channel.

31. The device of claim 29, wherein a size of the microposts varies along a longitudinal axis of the channel.

32. The device of claim 29, wherein the angle is in the range from about 10° to about 80°.

33. A microfluidic device, comprising:
a polymer scaffold defining at least one microchannel therein, an interior surface of the microchannel featuring chemical modifications patterned along at least one of a direction substantially perpendicular to a longitudinal axis of the channel or a direction substantially parallel to the longitudinal axis of the channel.
